(19) United States
(12) Patent Application Publication
(10) Pub. No.: US 2002/0020828 A1
(43) Pub. Date: Feb. 21, 2002

(54) Non-toxic ethylene glycol-based antifreeze/heat transfer fluid concentrate and antifreeze/heat transfer fluid

(76) Inventors: John W. Evans, Sharon, CT (US); J. Thomas Light, Lakeville, CT (US)

Correspondence Address: Cummings & Lockwood, Granite Square, 700 State Street, New Haven, CT, 06509-1960, US

(21) Appl. No.: 09/877,306

(22) Filed: Jun. 8, 2001

Related U.S. Application Data
(60) Provisional application No. 60/210,680, filed on Jun. 10, 2000.

(51) Int. Cl. C09K 5/00

(52) U.S. Cl. 252/73; 252/75

(57) ABSTRACT

A non-hazardous, reduced toxicity ethylene glycol-based antifreeze/heat transfer fluid concentrate is provided comprised of ethylene glycol, an antidote for ethylene glycol poisoning, such as propylene glycol, and selected additives. The antifreeze/heat transfer fluid concentrate may be combined with water to form a coolant solution for use in internal combustion engines.

This application claims the benefit of U.S. Provisional Application No. 60/210,680 filed Jun. 10, 2000.

### FIELD OF THE INVENTION

The present invention relates to a non-hazardous, reduced toxicity ethylene glycol-based antifreeze/heat transfer fluid concentrate comprised of (1) ethylene glycol, (2) an antidote for ethylene glycol poisoning that has a boiling point above about 150 degrees Celsius, preferably propylene glycol, and optionally (3) selected additives to impart desirable characteristics or properties to the concentrate. The concentrate may be combined with water to form an antifreeze/heat transfer fluid, such as a coolant for internal combustion engines.

### BACKGROUND OF THE INVENTION

For many years, antifreeze/heat transfer fluid concentrates have been used to form aqueous solutions used to cool internal combustion engines. These concentrates have also been used for deicing solutions used, for example, to deice airplanes or power lines. Alkylene glycols are often used as the base material for these antifreeze/heat transfer fluid concentrates. Alkylene glycols typically make up 95% by weight of the antifreeze/heat transfer fluid concentrate and, after blending with water, about 40% to 60% by volume of the solution used for cooling the engine in a vehicle. Conventional antifreeze/heat transfer fluid concentrates have for years been formulated using ethylene glycol (EG) as the base material. EG has proved to be an efficient and cost effective means of providing freezing and boiling protection for engine coolants. In addition to its use in engine coolants, EG is used in a variety of other applications, including production of polyethylene terephthalate for use in polyester films, fibers, and resins.

While EG has served effectively as a freeze point depressant and boiling point elevator for engine coolants, its major disadvantage is its toxicity to humans and other mammals if ingested. In the late 1960's and early 1970's, toxicity and environmental concerns resulted in the elimination of chromate and arsenite additives from engine antifreezes and coolants. Since that time, however, formulations have changed little. Our continuing attention to environmental problems has caused renewed concern about the health effects and disposal problems associated with engine antifreezes/heat transfer fluid concentrates.

Reports and studies made by The American Association of Poison Control Center's National Data Collection System stated that there were over 1.1 million poisonings reported by 63 poison control centers. These 63 centers serve about half of the U.S. population. About 92% of the reported poisonings occurred in the home and the majority were accidental (89%). Children under six years of age were involved in 62% of the incidences and ingestion accounted for 77% of the poisoning exposures. This same report noted 2451 poisonings related to glycols with 2372 exposures being accidental and, of those, 765 were related to children under six years of age.

In considering toxicity and disposal issues associated with antifreeze/heat transfer fluid concentrates, it is helpful to break down an engine antifreeze/coolant into its component parts (similar parts are found in all ethylene glycol and water-based thermal fluids):

1) Water—the primary heat removal fluid. The water content of a solution used as an engine coolant is typically 40% to 70% by volume depending upon the severity of the winter climate. In some warm weather areas, freezing temperatures are not encountered, and water with a corrosion prevention additive is used, or EG is added solely to raise the boiling point of the coolant solution.

2) Freezing Point Depressant and Boiling Point Elevator—in most cases EG is used in a range of 30% to 60% by volume to prevent freezing of the water during the winter. Addition of EG also raises the boiling point of the solution, and the same range of ethylene glycol is typically used during the summer in temperate regions and year round in warmer climates.

3) Additive Package—containing several different chemicals that are initially added to the glycol to form an antifreeze or concentrate and eventually blended with water to form the coolant. These additives are designed to prevent corrosion, deposit formation, and foaming, and are typically each present, in concentrations of 0. 1% to 3% by weight of the final coolant.

4) Contaminants—build up as the engine is used, and result from the following:

thermal or oxidative breakdown of glycol

lube oil and fuel accumulation

metals from cooling system corrosion

LD₅₀ values (acute oral toxicity ratings) are useful in comparing the relative toxicities of substances. The LD₅₀ value for a substance is the dose level (in mg/kg of body weight) administered at the beginning of a two week period, required to kill 50 percent of a group of laboratory rats. A coolant material that has an LD₅₀ value of 5,000 mg/kg or lower may be classified as hazardous, with lower LD₅₀ ratings indicative of increased toxicity. EG has an acute oral toxicity (LD₅₀) of 4,700 mg/kg. Although marginally hazardous by this rating system, EG is a known toxin to humans at relatively low levels (reported as low as 1,570 mg/kg) and consequently is classified by many regulatory authorities as a hazardous material. When ingested, EG is metabolized to glycolic and oxalic acids, which leads to an acid-base disturbance and results in kidney damage. In addition, EG has a sweet smell and taste, making it attractive to children and animals.

An accepted means for estimating the toxicity of a formulation containing several components is by a calculation method using the acute oral toxicity rating of each component. The LD₅₀ value of each formulation component is divided into the component's weight fraction in the formulation, and this “reciprocal” value is added to that of all the other components. The sum of this calculation is then divided into 1 and this is an estimate of the LD₅₀ of the formulation. The calculation method described above is used in Table 1 to estimate the LD₅₀ value of the standard ASTM antifreeze/coolant formulation, GM-6038.

TABLE 1
LD₅₀ Estimate

| | WT | LD₅₀ LD⁵⁰ | RECIPROCAL |
|---|---|---|---|
| INGREDIENT | FRACTION | (mg/kg) | (× 10⁷⁾ |
| EG | 0.9565 | 4700 | 2035 |
| NaNO₃ | 0.002 | 3750 | 5 |
| Na₂B₄O₇-5H₂O | 0.01 | 2660 | 38 |
| Na₂SIO₃-5H₂O | 0.0015 | 1280 | 12 |
| Na₃PO₄-12H₂O | 0.0045 | 17000 | 3 |
| NaMBT(50% SOLN) | 0.0055 | 3120 | 18 |
| NaOH | 0.002 | 500 | 40 |
| PLURONIC L-61 | 0.0005 | | — |
| GREEN DYE | 0.00005 | | — |
| WATER | 0.0175 | | — |
| | | | EG |
| SUMMATION OF | | | 2150 |
| RECIPROCAL | | | |
| 1/RECIPROCAL | | 4651 | |
| OR LD₅₀ | | | |

As shown in Table 1, ethylene glycol is the largest single component in the formulation, and its LD₅₀ value largely determines the estimated formulation LD₅₀. Because they are present in very low concentrations, the small contribution of the Pluronic L-61 and the dye were not considered. Also, the water present to solubilize the additives will tend to dilute the toxic effects of the other components and raise the LD₅₀ level of the formulation. The water is assumed to add no toxicity.

Additive packages may be added to an antifreeze/heat transfer fluid concentrate to replenish inhibitors. Supplemental coolant additives (SCAs) used to replenish inhibitors will often consist of from 5 to 15 different chemicals. These additives, as shown below, are broken down into major and minor categories depending on the amount used in an engine antifreeze/heat transfer fluid formulation:

| MAJOR (0.05 TO 3%) | MINOR 0.05% |
|---|---|
| BUFFER | DEFOAMER |
| CORROSION INHIBITORS | DYE |
| | SCALE INHIBITOR |
| | SURFACTANT |
| | CHELANTS |

The materials typically used as minor additives should not be of significance to the toxicity of engine antifreeze/heat transfer fluids because these materials usually have a relatively low toxicity and they are present in small quantities. Nitrite has the highest toxicity rating of the additives still frequently used in engine coolants, with an LD₅₀ for rats of 85 mg/kg (in the range of arsenite). The triazoles are moderately toxic while most of the other materials typically used in SCAs have LD₅₀ values that are in the same range as table salt and aspirin.

The toxicity of some antifreeze/heat transfer fluid additives is affected by their alkalinity. The more alkaline forms of silicate, phosphate, and borate have lower LD₅₀ values, and accordingly have a higher toxicity rating. Thus, the more alkaline metaborate (Na₂B₂O₄.4H₂O) has an LD₅₀ value of 1,700 mg/kg compared to the less alkaline tetraborate with a value of 2,300 mg/kg to 3,300 mg/kg. Similarly, sodium silicate with an SiO₂/Na₂O ratio of 1 has an LD₅₀ value of 600 mg/kg as compared to 1,600 mg/kg for the less alkaline silicate with an SiO₂/Na₂O ratio of 2.

The toxicity, or more appropriately the skin corrosiveness, of metasilicate (pH 13 @ 5%) is greatly neutralized when blended into an antifreeze/heat transfer fluid with a pH in the range of 10. The best example of this is the blending of phosphoric acid with potassium hydroxide in an antifreeze coolant or liquid SCA. The end product is a mildly alkaline salt which exhibits much less toxicity and corrosiveness than the starting materials.

The chemicals that may be included in an antifreeze/heat transfer fluid additive package have many common uses. Some of these chemicals, such as adipate, benzoate, carbonate, nitrite, phosphate, and silicate, are used in foods. Even nitrite, which has the lowest LD₅₀ (i.e., the highest oral toxicity) of any of the common additives, is used as a food preservative and in medicines. Borate, benzo triazole, carbonate, phosphate, silicate, and triethanolamine are used in soaps and detergents. As with all chemical products, additive chemicals should be handled with care, but in a formulated engine antifreeze/heat transfer fluid, these chemicals present no extraordinary health risk.

Worldwide nearly 400 million gallons of antifreeze/heat transfer fluid concentrates are sold every year. It is estimated that a significant percentage of this volume is disposed of improperly, resulting in contamination of the environment. Improper disposal by consumers is a major cause of this environmental contamination. Another major source of environmental contamination is leakage, spills and overflows from heavy duty vehicles. Experience with heavy duty vehicles shows that it is common to lose 10% of the antifreeze/heat transfer fluid volume after every 12,000 to 18,000 miles of operation due to leaks in the system components, such as the water pump, hose or clamps or radiator core. This rate of loss is equal to about one gallon/month for the typical highway truck, which is the equivalent of a leakage rate of one drop per minute. An antifreeze/heat transfer fluid leak rate of one drop per minute is likely to go unnoticed, but can in total add up to a significant loss.

In some operations using heavy duty vehicles, overflows account for far more antifreeze/heat transfer fluid loss than low level leaks at the water pump, hose clamps or radiator core. Overflows occur due to overheating or when a cooling system is overfilled. When a cooling system is overfilled, operation of the engine heats the antifreeze/heat transfer fluid, causing expansion of the fluid that cannot be contained in the system. Pressure relief valve lines typically allow excess fluid to escape to the ground. Small EG spills and leaks (less than a gallon) of antifreeze/heat transfer fluid eventually will biodegrade with little impact to the environment. However, before biodegradation occurs, these spills and leaks can present a toxic danger to pets and wildlife.

The environmental concerns detailed above, particularly as related to spillage and oral toxicity, are related to antifreeze/heat transfer fluid concentrates in which the major fraction (about 95%) is Ethylene Glycol (EG). Due to its toxic LD₅₀ rating of 4,700 mg/kg, EG is most hazardous when it exists as a concentrate (i.e., as sold to consumers in chain stores and markets), or when stored in commercial businesses (i.e., 55 gal drums).

The use of EG mixed with water in an engine coolant solution can also result in release of concentrated EG into the environment. At 200° F. (93.3° C.), the vapor pressure of water is 600 mm Hg, while the vapor pressure of EG at that temperature is just 10 mm Hg. Antifreeze/heat transfer fluid solutions used in internal combustion engines will typically start as 50% antifreeze (95% of the antifreeze being EG) and 50% water. Due to the difference in vapor pressure between water and EG, the solution will tend to become more concentrated in EG as water evaporates through “breathing” of the cooling system. Also as a result of the vapor pressure difference, heated antifreeze/heat transfer fluid solution that has been expelled from a cooling system will readily concentrate toward straight EG in the environment, increasing its oral toxicity. The hotter the solution expelled from the cooling system, the more rapidly the water content will pass into the atmosphere, leaving the more concentrated EG behind. Even though temporarily reduced in its hazardous rating level when diluted with water, EG and water-based antifreeze/heat transfer fluid solutions will approach EG's concentrated LD₅₀ value of 4,700 mg/kg when the solution is passed out of an automobile's cooling system vent into the environment. When the water is removed from the coolant solution, the antifreeze/heat transfer fluid concentrate is essentially returned to its initial concentrated state, and it is released into the environment as a hazardous, poisonous substance.

In recent years a base fluid concentrate containing about 95% propylene glycol (PG) has been used as a substitute for EG in many antifreeze/heat transfer fluid concentrate formulations to avoid the toxicity associated with EG. PG has an LD₅₀ value of 20,000 mg/kg as compared to EG's 4,700 mg/kg. PG is so non-toxic that it is approved by the U.S. Food and Drug Administration as a food additive. The greatest impediment to more widespread usage of PG as a base fluid for antifreeze/heat transfer fluid concentrates is its relatively high cost as compared to EG. Although PG has been used in some applications, EG remains the antifreeze base fluid of choice among the world's major antifreeze/heat transfer fluid concentrate manufacturers.

### SUMMARY OF THE INVENTION

The present invention relates to the homogeneous blending of an antidote into an ethylene glycol based antifreeze/heat transfer fluid concentrate, whereby the blended fluid is rendered essentially non-toxic in its concentrated form, and remains non-toxic when admixed with water for use as a heat transfer fluid or an engine antifreeze/coolant. In a preferred embodiment, the invention relates to blending of propylene glycol into an ethylene glycol based antifreeze/heat transfer fluid concentrate, thereby reducing the toxicity of the antifreeze/heat transfer fluid concentrate and rendering the resulting product essentially non-toxic. Buffers, corrosion inhibitors, dyes, scale inhibitors and other additives may be added to the antifreeze/heat transfer fluid concentrate to impart desired characteristics to the final product.

One advantage of the present invention is the formulation of an antifreeze/heat transfer fluid concentrate that is safe and non-toxic in all forms of storage: single gallon containers, 55 gallon drums, or any size of open container. The present invention results in a concentrate which is safe in the home, in chain stores and markets, and when drained from a heat exchange system (for example engines, and heating systems) and is subsequently left uncovered in the environment.

Another advantage of the present invention is formulation of a concentrate that remains safe when lost to the environment through a heat exchange system's vent, or by system leaks. The formulation of the invention assures that when the water fraction of the system's heat transfer fluid evaporates due to its high vapor pressure, the reduced EG rich fluid left behind remains essentially non-toxic.

Yet another advantage of the invention is to insure that the formulated antidote ingredient does not substantially reduce the anti-corrosive, or the freeze and boil point protection of the fluid to which it is added.

Other advantages of the composition of the present invention will become more readily apparent in view of the accompanying detailed description of the invention.

### DETAILED DESCRIPTION OF THE INVENTION

The present invention relates to an ethylene glycol (EG) based antifreeze/heat transfer fluid concentrate that is rendered essentially and permanently non-toxic by the addition of an antidote in a range from a minor fraction to a major fraction (by weight) of the concentrate. The antidote combines completely and forms a homogeneous mixture with the EG. Preferred embodiments of the invention are described below. The preferred embodiments disclosed herein are to be considered exemplary of the principles of the present invention and are not intended to limit the invention to the embodiments described. Various modifications will be apparent to those skilled in the art based on the teachings herein without departing from the scope or spirit of the invention disclosed herein.

As used herein and in the claims, “antidote” means a substance that prevents or counteracts the toxic effects of ethylene glycol. While not relying upon or limited to any particular theory or means by which the antidote may function, it is believed that in the preferred embodiment described below, the antidote effectively blocks the metabolism of EG and eliminates, or minimizes, the formation of glycolic and oxalic acids in the body. The acid-base disturbance within the kidneys well known to EG poisoning is thereby eliminated or minimized and the toxic effects of EG are eliminated.

In one embodiment of the invention, PG is added to EG as an antidote for EG toxicity and poisoning. EG (1,2-ethandiol) and PG (1,2-propandiol) are similarly structured chemicals. When their liquid forms are mixed, EG and PG will completely combine to form a homogeneous mixture at virtually any ratio of the two fluids.

Other additives can be included in the propylene glycol/ethylene glycol mixture to impart desirable properties for particular applications. For example, corrosion inhibitors, buffers, dyes, defoamers, scale inhibitors, surfactants and chelants may be added in appropriate amounts as desired. Sodium borates, sodium silicates, sodium phosphates, sodium nitrate, sodium nitrite, sodium molybdate, tolytriozolene or any other appropriate additive known to those skilled in the art can be included in the ethylene glycol/propylene glycol mixture.

The inventors have discovered that the addition of propylene glycol to ethylene glycol based antifreeze concentrates unexpectedly resulted in a mixture with a toxicity that is much less than would be predicted based upon the toxicity of the components by themselves. As described in detail below, tests have been conducted which demonstrate that the toxicity of mixtures of propylene glycol and ethylene glycol is much lower than would be predicted or expected.

In one embodiment of the invention, a heat transfer fluid concentrate is made by blending ethylene glycol with propylene glycol together with nine additives, including a small amount of water. Of the portion of the concentrate that is comprised of glycols, about 50 percent by weight is EG and about 50 percent by weight is PG. The calculation of the LD₅₀ value for this composition, calculated as described above, is shown in Table 2:

TABLE 2
LD₅₀ Estimate

| | WT | LD⁵⁰ | RECIPROCAL |
|---|---|---|---|
| INGREDIENT | FRACTION | (mg/kg) | (× 10⁷⁾ |
| PG | 0.4782 | 20,000 | 239 |
| EG | 0.4782 | 4,700 | 1017 |
| NaNO₃ | 0.002 | 3,750 | 5 |
| Na₂B₄O7-5H₂O | 0.01 | 2,660 | 38 |
| Na₂SIO₃-5H₂O | 0.0015 | 1,280 | 12 |
| Na₃PO₄-12H₂O | 0.0045 | 17,000 | 3 |
| NaMBT(50% soln) | 0.0055 | 3,120 | 18 |
| NaOH | 0.002 | 500 | 40 |
| PLURONIC L-61 | 0.0005 | | — |
| GREEN DYE | 0.00005 | | — |
| WATER | 0.0175 | | — |
| | | | 50% EG/PG |
| SUMMATION OF | | | 1372 |
| RECIPROCAL | | | |
| 1/RECIPROCAL | | 7289 | |
| OR LD⁵⁰ | | | |

Although the calculation predicted that the 50% blend of EG/PG would move slightly above the hazardous limit of 5,000 mg/kg, that level did not reach what was needed to provide an acceptably safe reserve margin for any reduction in the LD₅₀ value for the blended material during use. Such reductions could occur if residual amounts of EG remaining from a previous system fill became mixed into a fluid with a 50/50 EG/PG ratio. Also, an accidental addition of conventional EG antifreeze/heat transfer fluid concentrate to an EG/PG blend could increase the level of EG and reduce the LD₅₀ value for the mixture. Such additions could occur if the cooling system is “topped-up” and a conventional EG fluid is used, in error, as a replacement for the new EG/PG mix. Such inadvertent dilutions of the 50/50 ratio EG/PG mixture would quickly move the calculated LD₅₀ level down from the marginally safe level of 7,600 mg/kg, to be at or below the toxic limit of 5,000 mg/kg. If this were to occur, the operator of the system could unknowingly be using a toxic fluid while under the false premise that the fluid was non-hazardous and safe.

Toxicity testing of EG/PG blends was conducted for comparison to the theoretical values, and the results of that testing provided surprising and unexpected. Testing of the 50/50 EG/PG mixture was conducted to determine whether the calculated LD₅₀ level of 7289 mg/kg had actually been achieved. The tests were conducted at a laboratory approved by the United States Environmental Protection Agency (EPA) using standard “GPL” test procedures as described in the United States Food and Drug Administration Regulations, 21 C.F.R. Part 58 and EPA Good Laboratory Practice Standards 40 C.F.R. Part 792. Limit tests and range tests were conducted in preparation for determining the LD₅₀ value. A range test is a series of limit tests that establishes a range within which an LD₅₀ values lies.

Surprisingly, after completing a limit test at a dose of 5,000 mg/kg, and moving up to range tests at doses of 7,000 mg/kg and 11,000 mg/kg of the new 50/50 EG/PG fluid, unexpected results were observed. There were no ill effects on the laboratory rats even at doses of 11,000 mg/kg, including no indications of changes in their normal appearance or activity. The 11,000 mg/kg dose level used for the tests was at the end of the upper range at which it was expected that the 50/50 EG/PG fluid would be fatal and all rats would be affected. A subsequent range test was conducted at a dose level of about 21,000 mg/kg of the 50/50 EG/PG blend. The results of this range test were essentially the same, except a sluggishness was noted in the rats, which lasted for about a day, after which time the rats returned to normal behavior. At the approximately 21,000 mg/kg dose level, the rats' stomachs were completely filled, and therefore this was the maximum possible dose that could be administered without causing physical damage to the stomach. Because one half of the rats did not die and the dosage could not be increased, an LD₅₀ value could not be established for the 50/50 EG/PG blend.

Subsequent testing was conducted with the concentrations of EG and PG changed to 70% and 30%, respectively. With this fluid composition, the limit test results showed no ill effects on laboratory rats at a 5,000 mg/kg dose. Range tests showed no ill effects on the laboratory rats at doses of 7,000 mg/kg or at doses of 11,000 mg/kg. Accordingly, the LD₅₀ value for this EG/PG blend is necessarily substantially above 11,000 mg/kg, a very safe level.

These test results were surprising and unpredictable, and resulted in the discovery that the addition of PG to an EG based antifreeze/heat transfer concentrate results in a reduction in the toxicity of the blended formulation that is far greater than would be expected or predicted, such as by the calculated LD₅₀. The tests, that show that a 50/50 EG/PG blend is so low in toxicity that an LD₅₀ value cannot be established and that show that a 70/30 EG/PG blend has an LD₅₀ value in excess of 11,000 mg/kg, confirm that the PG is acting as an antidote for toxicity of the EG fraction within the antifreeze/heat transfer fluid concentrate. It is hypothesized that the PG interferes with the oxidation of the EG, when metabolized, and that the acidic action within the kidneys does not occur, or is reduced to a level which does not damage the kidneys, and acute poisoning does not occur.

Accordingly, at concentrations of 50% EG/50% PG to 70% EG/30% PG, the mixtures have been proven to: (1) have substantially higher LD₅₀ values (greater than 11,000 mg/kg) than previously known or anticipated, (2) to have LD₅₀ levels which were extremely safe and non-hazardous, and (3) possess an unforeseen LD₅₀ reserve level which would allow for substantial inadvertent dilutions of EG concentrate. Additionally, the EG/PG blended fluid remains “safe” in all stored or in use conditions due to the similar saturation temperatures, and vapor pressure of the EG and PG base fluids. The ratio of PG to EG in any fluid lost to the environment from venting or draining will always remain at approximately the ratio of the PG to the EG in the blended concentrate, rendering the lost coolant essentially and permanently non-toxic and environmentally “safe”.

In a preferred embodiment of the present invention, a heat transfer fluid concentrate contains about 30% PG by weight and about 70% EG by weight. At this concentration, the PG functions as an antidote for ethylene glycol poisoning. The concentrate may also include additives as desired for buffering, corrosion inhibiting, defoaming, dying, scale inhibiting, surfacting, or chelating, and at least enough water to keep any of the additives used, that require water to be in solution, dissolved. In its most concentrated form, the EG and PG portion of the entire formulation would typically be about 95 weight percent of the concentrate, the additive portion would be about 1.5 weight percent of the concentrate, and water would be about 3.5 weight percent of the concentrate.

The concentrate can also be formulated to contain more water if a more diluted heat transfer fluid is desired. The concentrate may also be combined with water to form a coolant solution for use in an internal combustion engine. In either case, the EG plus PG portion and the additive portion of the formulation is decreased on a weight percent basis of the solution. However, the relative ratio of PG to EG in these diluted formulations will remain the same, that is, the PG will remain at about 30 weight percent of the sum of the weights of the EG and the PG in the solutions.

The use of PG as an antidote for EG toxicity is especially useful in fluids that are used as antifreezes or coolants in engines. After they are mixed together, EG and PG remain chemically stable and remain permanently mixed in a homogeneous fluid blend where neither fluid will separate from the other. The result is a fluid which will remain “as blended” at any ratio of one to the other. This stability of the blended fluids is important for long term storage of heat transfer fluid concentrates formed by combinations of these materials.

When heat is applied to the blended EG/PG concentrate, or to a coolant solution containing an EG/PG blend admixed with water, the combined EG/PG solution fraction will remain stable and will not separate. Also, the proportions of EG and PG present in the heated mixture will remain relatively constant. The tendency of the two fluids to remain combined and act as one when heated is due to their very close boiling points. EG has a boiling point of 390° F. (198.8° C.) at atmospheric pressure, while PG a has a boiling point of 369° F. (187.2° C.) at atmospheric pressure. As a result, when combined and heated, the two fluids will boil off at about the same rate, and their proportions relative to each other in the remaining fluid will not change significantly. An antidote that has a boiling point below about 302° F. (150° C.) at atmospheric pressure would be less desirable in a mixture with EG because the boiling point is too far below that of EG and separation of the fluids by evaporation could be a problem.

When EG/PG blends are mixed with water and heated, as occurs in coolant solutions used in engines, the water fraction will readily “boil-out” or evaporate from the heated coolant solution when exposed to the ambient atmosphere. Water has a boiling point of 212° F. (100° C.). As a result, water will rapidly evaporate from the heated coolant solution if the heated coolant solution is released to the atmosphere, which can occur, for example, with the venting of an over I heated engine. If this occurs, however, the EG and PG remain present in approximately the same relative proportions in the remaining fluid, thereby maintaining the level of the PG antidote in that remaining fluid.

The vapor pressure of a fluid is the pressure of a vapor in equilibrium with its liquid form, and provides an indication of the evaporation rate of a fluid. The higher the vapor pressure of the fluid, the more readily the fluid's vapor will pass out of the liquid into the ambient atmosphere above it. At 200° F., EG has a vapor pressure of 10 mm Hg, and PG a vapor pressure of 16 mm Hg. Because the vapor pressures of EG and PG are similar, they will evaporate at about the same rate. By contrast, at 200° F., water has a vapor pressure of 600 mm Hg, and water will evaporate from a solution much more rapidly than either EG or PG. If a heated aqueous solution containing a blend of EG and PG is left exposed to the ambient atmosphere, water will evaporate and the solution will become concentrated toward the base EG/PG ratio becoming substantially voided of the water fraction.

In all the above described situations it can be seen that, in each occurrence, the resultant fluid remaining after boiling or evaporation has approximately the same ratio of EG to PG as was present the originally blended EG/PG mixture.

As will be recognized by those of ordinary skill in the art based on the teachings herein, numerous changes and modifications may be made to the above-described embodiment of the present invention without departing from its scope or spirit. For example, another antidote for ethylene glycol poisoning, having a boiling point above about 150° C. (302° F.) might be used solely or in combination with PG. Also, the relative concentration of PG to EG may be varied, for example by changing the PG/EG ratio to 40/60. Acceptable concentrations of PG in the total of the ethylene glycol and propylene glycol portion of the formulation would be in the range of about 30 to about 50 weight percent. Accordingly, the detailed description of the preferred embodiment is to be taken in an illustrative rather than a limiting sense.

What is claimed is:

1. An antifreeze/heat transfer fluid concentrate composition comprising:
(a) ethylene glycol; and
(b) an antidote for ethylene glycol poisoning that has a boiling point above about 150° C. (302° F.) at atmospheric pressure.

2. The composition of claim 1 wherein the antidote for ethylene glycol poisoning is propylene glycol.

3. An antifreeze/heat transfer fluid concentrate composition containing an antidote for ethylene glycol poisoning comprising:
(a) from about 50% to about 70% by weight ethylene glycol; and
(b) from about 30% to about 50% by weight propylene glycol.

4. The composition of claim 2, further comprising at least one of the following additives: a buffer, corrosion inhibitor, defoamer, dye, scale inhibitor, surfactant or chelant.

5. The composition of claim 4, further comprising water in an amount sufficient to dissolve any additives that are not soluble in either ethylene glycol or propylene glycol.

6. The composition of claim 3, further comprising at least one of the following additives: a buffer, corrosion inhibitor, defoamer, dye, scale inhibitor, surfactant or chelant.

7. The composition of claim 6, further comprising water in an amount sufficient to dissolve any additives that are not soluble in either ethylene glycol or propylene glycol.

8. A composition for use as an antifreeze/heat transfer fluid comprising:
(a) ethylene glycol;
(b) an antidote for ethylene glycol poisoning that has a boiling point above about 150° C. (302° F.) at atmospheric pressure; and
(c) water.

9. The composition of claim 8, wherein the antidote for ethylene glycol poisoning is propylene glycol.

10. The composition of claim 8, further comprising at least one of the following additives: a buffer, corrosion inhibitor, defoamer, dye, scale inhibitor, surfactant or chelant.

11. A composition for use as an antifreeze/heat transfer fluid containing an antidote for ethylene glycol poisoning comprising ethylene glycol, propylene glycol, and water, wherein the proportions of ethylene glycol and propylene glycol in the fluid are such that ethylene glycol comprises from about 50% by weight to about 70% by weight of the total weight of ethylene glycol and propylene glycol in the fluid, and propylene glycol comprises from about 30% by weight to about 50% by weight of the total weight of ethylene glycol and propylene glycol in the fluid.

12. The composition of claim 11, further comprising at least one of the following additives: a buffer, corrosion inhibitor, defoamer, dye, scale inhibitor, surfactant or chelant.

13. The composition of claim 11, wherein ethylene glycol comprises about 70% by weight of the by weight of the total weight of ethylene glycol and propylene glycol in the fluid, and propylene glycol comprises about 30% by weight of the total weight of ethylene glycol and propylene glycol in the fluid.

14. The composition of claim 13, further comprising at least one of the following additives: a buffer, corrosion inhibitor, defoamer, dye, scale inhibitor, surfactant or chelant.
